(19) United States
(12) Patent Application Publication
(10) Pub. No.: US 2025/0032825 A1
(43) Pub. Date: Jan. 30, 2025

(54) BREATHING APPARATUS SYSTEM

(71) Applicant: AVON PROTECTION SYSTEMS, INC., Cadillac, MI (US)

(72) Inventors: Samuel David Whyman, Lutherville, MD (US); Mark Patrick McJunkin, Senoia, GA (US); William Michael Lydick, Sykesville, GA (US); Clinton Cain Mayhue, Auburn, GA (US); Joseph Craig Martin, Dacula, GA (US)

(73) Assignee: AVON PROTECTION SYSTEMS, INC., Cadillac, MI (US)

(21) Appl. No.: 18/716,548

(22) PCT Filed: Dec. 6, 2022
(86) PCT No.: PCT/US2022/080964

§ 371 Date: Jun. 5, 2024

Related U.S. Application Data
(60) Provisional application No. 63/265,160, filed on Dec. 9, 2021.

(51) Int. Cl. A62B 9/04; A62B 9/02

(52) U.S. Cl. CPC A62B 9/04; A62B 9/022

(57) ABSTRACT

A valve for a breathing apparatus system includes a housing extending axially from a first end to a second end, with the first end fluidly coupled to the mask and the second end configured to fluidly couple with a source of breathable air. An air flow path extends through the housing between the first end and the second end.

### CROSS-REFERENCE TO RELATED APPLICATION(S)

This application claims priority to U.S. Provisional Patent Application No. 63/265,160, filed Dec. 9, 2021, which is incorporated herein by reference in its entirety.

### BACKGROUND

Breathing apparatuses, including personal or self-contained breathing apparatuses (SCBAs), are known for use in adverse breathing environments such as fire, smoke, chemical dispersion, or underwater environments. Breathing apparatus systems typically include a source of breathable air, an air delivery component such as a mask, one or more valves for controlling delivery of breathable air, and one or more indicators for pressure, remaining air, or the like.

### BRIEF SUMMARY

In one aspect, the disclosure relates to a valve for a breathing apparatus system with a mask supplied by a source of breathable air. The valve includes a housing extending axially from a first end to a second end, with the first end fluidly coupling to the mask and the second end configured to fluidly couple with a source of breathable air. The valve can also include an air flow path extending through the housing between the first end and the second end, a central tee located within the housing and at least partially defining the air flow path, a shuttle surrounding the central tee and movable between a first position and a second position, and a seal carried by the shuttle and surrounding the central tee.

In another aspect, the disclosure relates to a breathing apparatus system. The breathing apparatus system includes a mask, a component fluidly coupled with mask and having a first seal, and a valve receiving the component. The valve includes a housing extending axially from a first end to a second end, with the mask coupled to the first end and the component coupled to the second end, an air flow path extending through the housing between the first end and the second end, a shuttle within the housing and movable between a first position and a second position, and a second seal carried by the shuttle and axially spaced from the first seal. At least one of the first seal and the second seal can block the air flow path as the shuttle is moved between the first position and the second position.

### BRIEF DESCRIPTION OF THE DRAWINGS

In the drawings:

FIG. 1 is a front view of an exemplary breathing apparatus system illustrating a manifold for receiving air cylinders, a first stage regulator, and a cylinder filling assembly.

FIG. 2 is a perspective view of a digital gauge that can be utilized with the breathing apparatus system of FIG. 1 in accordance with various aspects described herein.

FIG. 3 is a side perspective view of the digital gauge of FIG. 2.

FIG. 4 is a schematic view of a display that can be utilized in the digital gauge of FIG. 2 in a first configuration.

FIG. 5 is a schematic view of a display that can be utilized in the digital gauge of FIG. 2 in a second configuration.

FIG. 6 is a schematic view of a display that can be utilized in the digital gauge of FIG. 2 in a third configuration.

FIG. 7 is a schematic view of a display that can be utilized in the digital gauge of FIG. 2 in a fourth configuration.

FIG. 8 is a schematic view of a display that can be utilized in the digital gauge of FIG. 2 in a fifth configuration.

FIG. 9 is a perspective view of a valve system that can be utilized with the breathing apparatus system of FIG. 1 in accordance with various aspects described herein.

FIG. 10 is a perspective view of internal components relating to the valve system of FIG. 9 in accordance with various aspects described herein.

FIG. 11 is a perspective view of a circuit board that can be utilized with the valve system of FIG. 9.

FIG. 12 is a perspective view of a breathing mode selector switch that can be utilized with the breathing apparatus system of FIG. 1 in accordance with various aspects described herein.

FIG. 13 is a top perspective view of a circuit board that can be utilized within the breathing mode selector switch valve of FIG. 12.

FIG. 14 is a bottom perspective view of the circuit board of FIG. 13.

FIG. 15 is a perspective view of a coaxial mask connection that can be utilized with the breathing apparatus system of FIG. 1 in accordance with various aspects described herein.

FIG. 16 is a perspective view of a reinforced hose that can be utilized with the breathing apparatus system of FIG. 1 in accordance with various aspects described herein.

FIG. 17 is a cross-sectional view of a quick-disconnect valve that can be utilized with the breathing apparatus system of FIG. 1 in accordance with various aspects described herein, with the quick-disconnect valve in a first configuration.

FIG. 18 is a cross-sectional view of the quick-disconnect valve of FIG. 17 in a second configuration.

FIG. 19 is a top view of the quick-disconnect valve of FIG. 17.

FIG. 20 is a perspective view of the quick-disconnect valve of FIG. 17.

FIG. 21 is a front view of the quick-disconnect valve of FIG. 17.

FIG. 22 is a right side view of the quick-disconnect valve of FIG. 17.

### DETAILED DESCRIPTION

Aspects of the disclosure relate to a breathing apparatus system and components thereof. Portions of the system will be described in the context of a self-contained breathing apparatus (SCBA). It will be understood that the disclosure can have general applicability, including in other breathing apparatuses such as for underwater or chemical-laden environments, as well as in other air or fluid delivery systems.

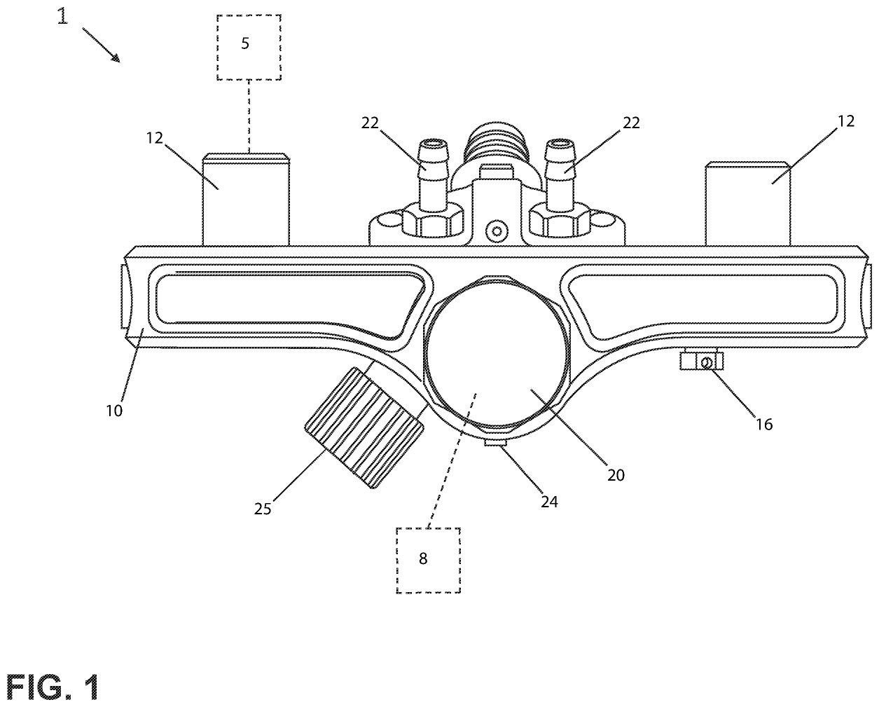

Turning to FIG. 1, one exemplary breathing apparatus system 1 (hereafter “system 1”) is illustrated in the form of a SCBA having a manifold 10 with bottle ports 12 configured to couple to a source of breathable air 5, such as high pressure air bottles or canisters (schematically illustrated in dashed line). In some examples, a regulator adapter can be included for receiving a first stage regulator 20. The first stage regulator 20 can be configured to deliver air from the bottle ports 12 to a mask 8 (schematically illustrated in dashed line), such as a standard gas mask, a SCBA mask, or the like. It is understood that the mask 8 can include a second stage regulator for additional regulation of air supply to a user.

An internal channel or port can deliver air from the bottle ports 12 to the first stage regulator 20. In some examples, the first stage regulator 20 can also include a low pressure hose attachment 22 for delivering air pressure through a hose to the operator's mask 8. A low pressure relief valve 24 can also be provided to allow an operator to regulate the amount of pressure delivered to their mask 8 or to allow air exceeding a desired pressure to be bled from the regulator 20. An on/off valve 25 can also be provided for controlling, starting, or stopping delivery of air from the regulator adapter into the first stage regulator 20. The manifold 10 can further include a high pressure relief valve 16 that is attached to manifold 10 for providing release of air pressure from the system 1.

Portions of the system 1, including the manifold 10, can include additional components including ports for receiving data gauges, tools, fittings, or couplings, as well as valves or other control mechanisms for monitoring, controlling, or modifying a supply of breathing air. Aspects of the disclosure will be described below that can be utilized in the exemplary SCBA and system 1. It will be understood that the described aspects can have applicability in any breathing apparatus or system including, but not limited to, a portable breathing apparatus, an underwater breathing apparatus, a body-mounted breathing apparatus, or the like.

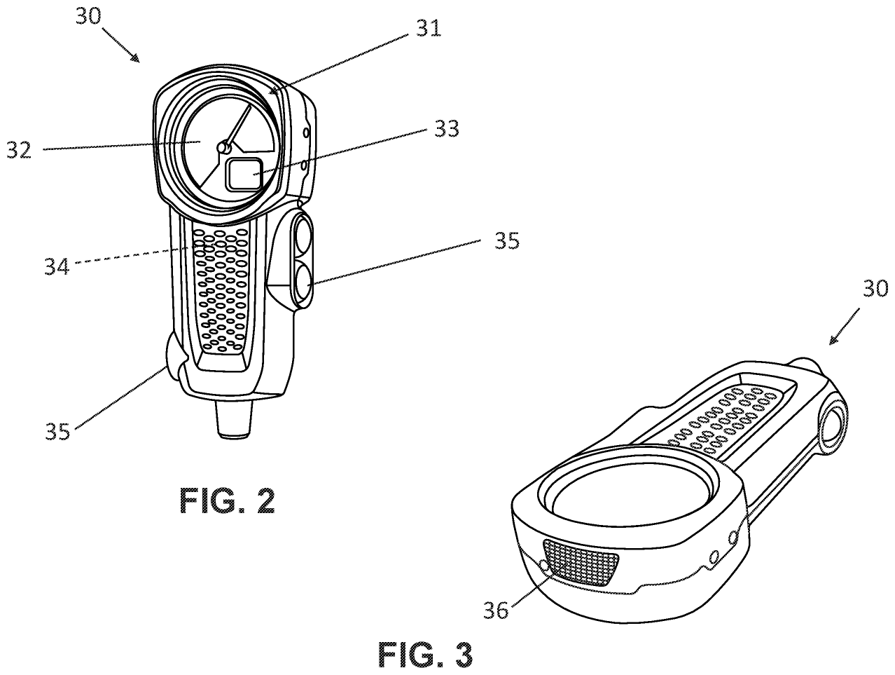

Referring now to FIGS. 2 and 3, a gauge 30 is illustrated that can be used in the system 1. The gauge 30 can be configured to provide system information including, but not limited to, a cylinder pressure level, a current battery level, a low battery state, a system breathing mode, a change in system breathing mode, an external chemical or gas detection. In some examples, the gauge 30 can be configured to be wearable on a user's chest.

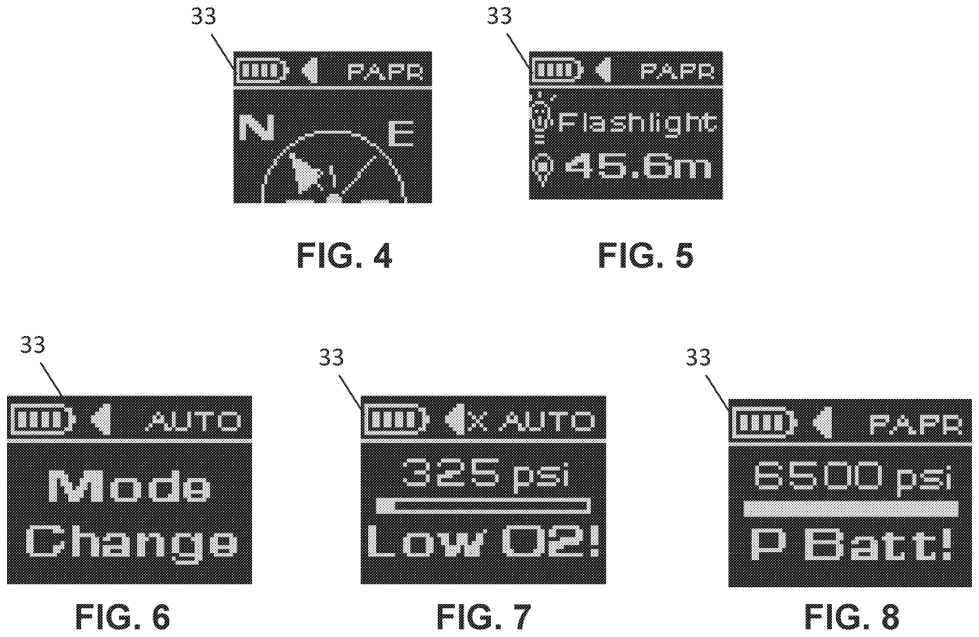

The gauge 30 can be in wireless or wired signal communication with other portions of the system 1, including the manifold 10 (FIG. 1). In some examples, a sensor can be provided in the system 1 and in signal communication with the gauge 30 using a wired or wireless connection. In one example of operation, a remote transducer can be provided in the system 1 and in signal communication with the gauge 30. In such a case, the gauge 30 can receive or determine a cylinder pressure level based on a received signal from the remote transducer. Other components that can be provided in the gauge 30 include, but are not limited to, a distance range finding device, laser light detection and ranging (LiDAR) device, physical positioning device, geographic positioning system (GPS), communication device, compass, barometer, or the like (see also FIGS. 4-8 for examples). It is contemplated that the gauge 30 can operate in multiple modes for comprehensive indication or analysis of operation of the system 1.

The gauge 30 can include a user interface 31. The user interface 31 can include a display, touch screen, physical button, toggle, switch, speaker, microphone, or the like, or combinations thereof. In the non-limiting example shown, the user interface 31 includes a needle display 32, an electronic screen 33, a speaker 34, and a button 35.

The user interface 31 can also include an alarm. Such an alarm can include an audio or visual indicator, including by way of the needle display 32, electronic screen 33, or speaker 34. Such an alarm can also be controllably operated by the user interface, including a volume adjustment, mute, brightness adjustment, or alarm on/off setting, or the like. In some examples, the alarm can be configured to indicate a low battery state using either or both of an audible indicator or a visual indicator. In some examples, the alarm can be configured to indicate a low pressure state of a gas canister using either or both of an audible indicator or a visual indicator. The alarm can also have a variable volume or a variable brightness based on a predetermined threshold or urgency of the signal, such as a medium-volume audio indicator when cylinder pressure reaches a first value and a maximum-volume indicator when the cylinder pressure reaches a second value. The alarm can also have a variable sound or variable visual indicator based on a predetermined threshold. In one non-limiting example, the alarm can generate a first beeping pattern and first light signal when cylinder pressure reaches 50% and a second beeping pattern and a second light signal when cylinder pressure reaches 15%. In another non-limiting example, the alarm can generate an audio output when cylinder pressure reaches a first pressure setpoint, and a visual output when cylinder pressure reaches a second pressure setpoint.

In some examples, the user interface 31 can include a physical mute button 35 for the alarm. The mute button 35 can operate to continuously mute any future alarms, or to mute for a predetermined amount of time before the alarm resets to a default setting, in non-limiting examples. The mute button 35 can be positioned at any suitable location on the gauge 30, including on a top portion, side portion, bottom portion, or the like. In addition, multiple mute buttons 35 can be provided though this need not be the case.

The needle display 32 can be an analog display or an electronic display. In some examples, the needle display 32 can include a motorized mechanical gauge pointer. In some examples, the needle display 32 can include a color changing LED illuminated needle whereby the needle color is configured to indicate a system aspect, such as a system cylinder pressure. In some examples, the needle display 32 can be in the form of an electronic display screen with a visual representation of a needle pointer. Furthermore, the needle display 32 can include a color-coded background such as “red, yellow, green,” or “high, medium, low,” or the like. Such color coding can be provided in a physical or analog manner, such as with a sticker or painted background, or electronically, such as with an electronic display background. In some examples, the needle display 32 can be configured to indicate multiple different states by way of a switch or mode selector wherein the background color coding can be changed for each state, e.g. “battery” vs. “cylinder pressure” vs. “estimated operation time remaining” or the like. The color coding can also be provided by way of a set of controllable light sources, such as addressable light-emitting diodes (LEDs) having a color changing adjustment feature. Such color coding can also be automated, such as by way of a sensing mechanism e.g. a radio frequency identification tag positioned within a gas cylinder and in communication with the gauge 30.

FIG. 3 further illustrates that a light source 36 can be provided with the gauge 30. In some examples the light source 36 can include a high-power LED for illumination in low visibility environments. In some examples the light source 36 can include an ultraviolet LED configured to perform chemical detection in the surrounding environment or to activate an external device. While illustrated on a top portion of the gauge 30, the light source 36 can be located on any suitable portion of the gauge 30.

FIGS. 4-8 illustrate some examples of screen readouts for the screen 33. It will be understood that such examples are for illustrative purposes and are not limiting in any way. It is contemplated that the screen 33 can include an organic light-emitting diode (OLED) display, such as a micro-OLED display. Various screen elements can be provided including a battery readout, a pressure level, a compass readout, a flashlight on/off status, a remote alarm mute status, a digital pressure readout, a system breathing mode, a system auto mode change indication, or a remote gas detector interface alarm. FIG. 4 illustrates a battery level, compass, and powered air purifying respirator (PAPR) breathing mode. FIG. 5 additionally illustrates a flashlight-on status and a visibility indicator. FIG. 6 additionally illustrates a mode change confirmation and an auto-mode select status. FIG. 7 additionally illustrates a low-pressure or low-oxygen alarm. FIG. 8 additionally illustrates a battery alarm and a current tank pressure. It will be appreciated that any combination of readout, alarm, indicator, or user input or selection is contemplated for the screen 33.

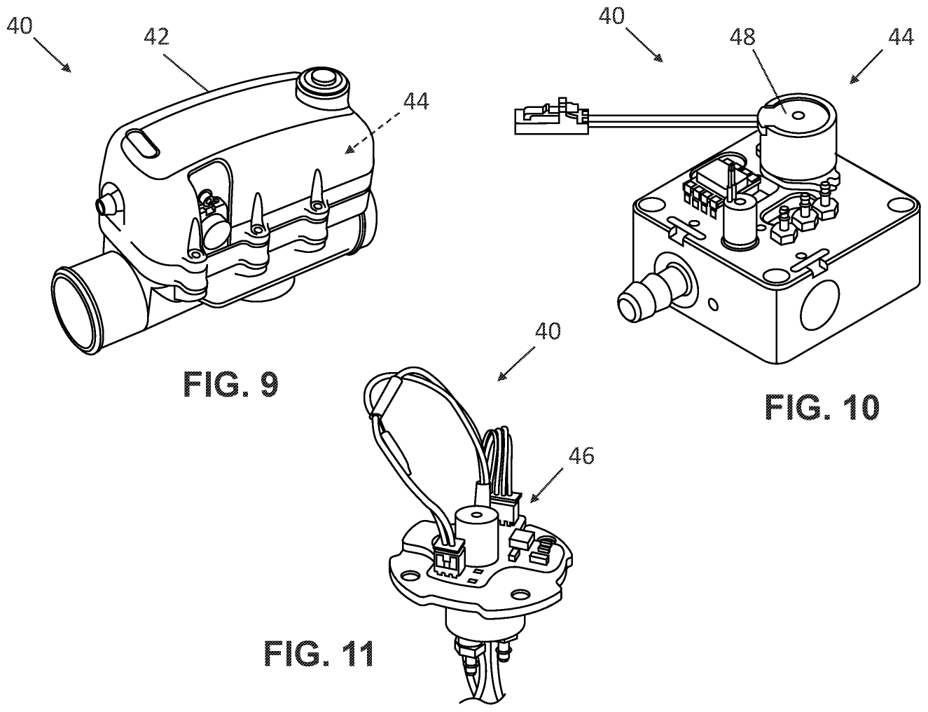

Referring now to FIGS. 9-11, an improved valve system 40 is shown that can be utilized in the system 1 (FIG. 1). In some examples, the valve system 40 can include an electronic demand valve 44 such as a pilot-operated, second stage demand valve. It will be understood that the valve system 40 can be provided or mounted at any suitable location in the system 1, including anywhere on an operator's body, a protective suit, a wearable or portable pack-mounted breathing apparatus, or the like. In some examples, the valve system 40 can be positioned within a threaded mask mount, or on a breathing hose with the use of a manifold arrangement as shown in FIG. 9. The pressure transducer may be positioned locally to the facepiece, or remotely and connected via a length of tubing.

The valve system 40 can include a housing 42 carrying at least the electronic demand valve 44 and internal circuitry 46 as shown. The housing 42 can have a compact form for improved user flexibility. A micro proportional valve 48 can be provided and configured to control a flow of air through a valve disc, such as a laser drilled valve disc, to supply breathing gas. In some examples, a pressure transducer linked to a facepiece can provide a signal to the micro proportional valve 48 for control of airflow.

The valve system 40 can include sensors configured to detect external or internal air pressure, external or internal changes in pressure, external or internal temperature, or the like. The valve system 40 can optionally include a controller configured to receive signals from such sensors and transmit received signals to other components, including other components in the system 1.

Some examples of operation of the valve system 40, including the electronic demand valve 44, will be described below. It will be understood that such examples are not limiting, and are provided for illustrative purposes.

In one example, the valve system 40 can sense an internal mask pressure. The valve system 40 can provide or instruct an automatic mode change to a SCBA mode of the system 1 based on the sensed mask pressure, for example in response to a negative mask pressure exceeding a predetermined threshold value.

In one example, the valve system 40 can include an internal pressure transducer. Such a pressure transducer can be utilized to determine a negative pressure fit check for a user. The valve system 40 can confirm that a threshold pressure, such as a 6-inch H2O negative pressure in one example, can be maintained with the user holding their breath. The valve system 40 can also validate with a head-up display (HUD) message or other confirmation mechanism.

In another example, the valve system 40 can replace a first breath mechanism of the system 1. Additionally or alternatively, the valve system 40 can be configured as a backup component providing breathable air to a user based on a status of other components in the system 1, such as an external filter blockage in one example.

In another example, the valve system 40 can include a controller with instructions, software, or other code to determine a most critical consumable value. Additionally or alternative, the valve system 40 can compensate for changes in breathing performance based on environmental conditions, such as low-temperature conditions.

In another example, the valve system 40 can be configured to sense or determine breathing rate telemetry for a user. Additionally or alternatively, enhanced telemetry can be provided including transmitting or reporting signals to an external server, such as a control center. Additionally or alternatively, the valve system 40 can record a mask pressure value to memory based on a predetermined threshold or value, such as recording a sensed mask pressure during an alarm state or at a physical location, including a global position.

In another example, the valve system 40 can generate or provide an alarm indicative of an end of service time. In such a case, the valve system 40 can provide pneumatic vibrations by interrupting breathing flow to form the alarm.

In another example, the valve system 40 can be utilized in a way to prevent physical changes in elastomeric elements that may occur due to environmental changes, such as material stiffening in low temperature external environments. In one implementation, the valve system 40 can operate under a higher operating pressure, e.g. being “driven harder” to prevent material stiffening. In another implementation, a heating element can be provided with the demand valve to maintain a component temperature within a predetermined temperature range.

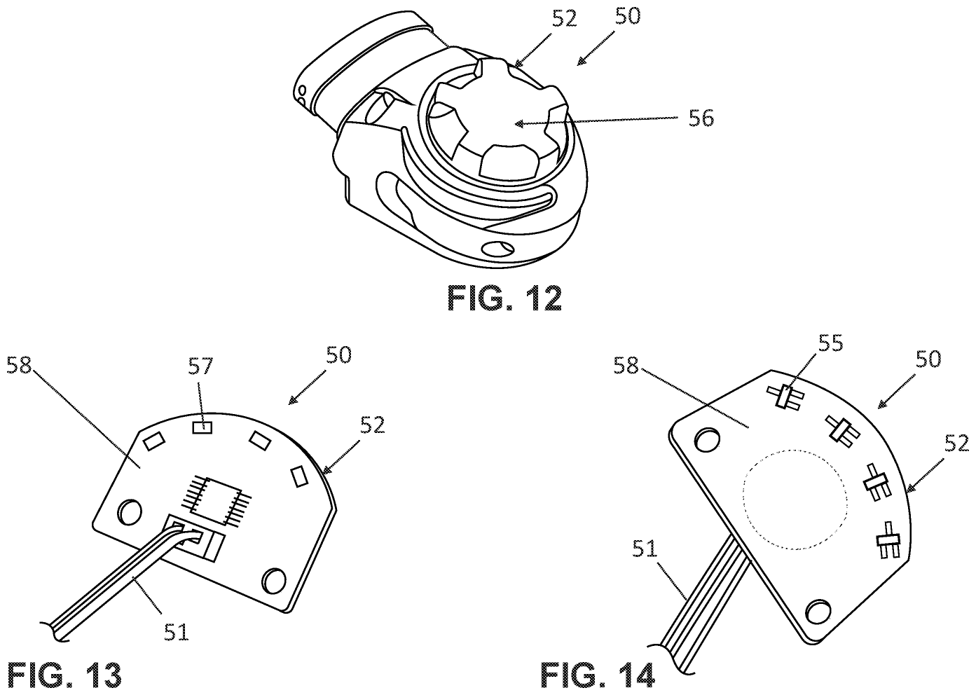

With general reference to FIGS. 12-14, portions of a changeover system 50 are illustrated that can be utilized in the system 1 (FIG. 1). The changeover system 50 can form an automated changeover system that can include or cooperate with the valve system 40, including the housing 42 containing a micro solenoid valve such as the micro proportional valve 48 (FIG. 10). The micro solenoid valve can be controllably operated or triggered by a local signal or a remote signal from the changeover system 50. In some examples, the changeover system 50 can be configured to act as an air pilot for a demand valve, including a compact demand valve (CDV), or the demand valve 44 (FIG. 9).

The changeover system 50 can include an aluminum manifold prototype configured for installation into a breathing hose to define a hose-end selector 52. A hose-end selector switch 56 can be provided and include a fully electronic system for switching between air sources. In some examples, the changeover system 50 can include a Hall effect type, multiple-position (e.g. four-position) selector switch 56. Such a switch 56 can enable the use of an interlocking dial mechanism, including a 30-degree interlocking dial mechanism, for user selection. While the switch 56 is illustrated as a manual knob or dial mechanism, other implementations are contemplated including an electronic display or a voice-activated switch in non-limiting examples.

FIGS. 13-14 illustrate top and bottom views of one example of a Hall effect sensor board 58 that can be utilized. The sensor board 58 can include at least one Hall effect sensor 55 (with four sensors 55 provided in the illustrated example), as well as an inverter and resistor array 57. The exemplary sensor board 58 can be arranged such that only three wires 51 are required for four selector states, such as “Vin,” “GND,” and “Vout” in a non-limiting example. The Hall effect sensor output signals can be combined through a resistor array, e.g. the inverter and resistor array 57, to provide discrete voltage outputs that can be read and interpreted by an analog-to-digital converter (ADC) to determine a position of the switch 56 (FIG. 12).

In some examples, a rotary encoder or potentiometer device can be used in place of the at least one Hall Effect sensor. Such an arrangement can provide for a reduction in part complexity for the changeover system 50.

Any suitable sensor can be utilized in the changeover system 50, including gas detection sensors, pressure sensors, temperature sensors, acoustic sensors, voltage sensors, or the like, or combinations thereof. In one example, carbon monoxide breakthrough can be determined by the changeover system 50 using in-loop gas detection by the sensor board 58. In another example, a microphone can be provided to enable a voice-activated mode change for the switch 56. Such a microphone can be provided in combination with or in place of the illustrated manual switch 56. In still another example, a remote device can be in signal communication with the sensor board 58 and transmit a wired or wireless signal for changing a state selection for the switch 56.

It can also be appreciated that the use of an electronic switch 56 for the changeover system 50 can provide for a selector mechanism that is more easily positioned remote to a user's breathing hose. Such an arrangement provides for improved flexibility for a user when changing from one breathing source to another.

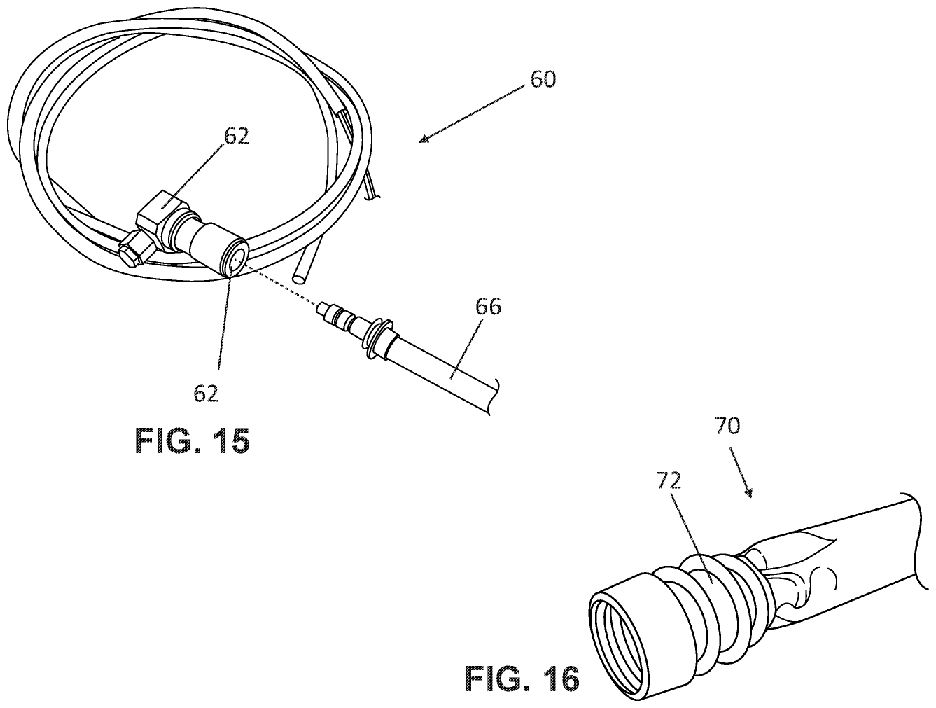

FIG. 15 illustrates an improved coaxial interface 60 for in-mask systems. The interface 60 can include a miniature, combined, three-pin electronic and single shut off pneumatic coaxial connection 62. The pneumatic coaxial connection 62 can be used for connection to an in-mask system via hose 66. The interface 60 can also be configured to couple to an external securing mechanism. In one example, the external securing mechanism can include a 40 mm threaded union to maintain connection. In this manner, the improved coaxial interface 60 can form a mask pass-through connection for use in the system 1 (FIG. 1).

FIG. 16 illustrates an improved breathing hose 70 that can be used in multiple environments. In some examples, the breathing hose 70 can be used as part of a chemical, biological, radiological, and nuclear (CBRN) defense system. The breathing hose 70 can include an inner reinforced polyurethane hose configured to form an air-tight breathing seal with cuffed ends. A stainless steel spring wire can prevent the inner hose from deforming under pressure with undesirable flow restriction. In some examples, a lightweight material such as Gore-Tex can replace butyl rubber as the outer material and vapor barrier, providing a reduction in weight and an increase in hose flexibility. The improved breathing hose 70 can have a smooth outer surface without need of corrugations. In some examples, a coaxial seal arrangement can be formed wherein thick rubber bands 72 provide compliant areas for the inner and outer hose layers to seal against. In this manner, the breathing hose 70 can have a reduced weight compared to traditional breathing hoses, provided for improved user flexibility in operation.

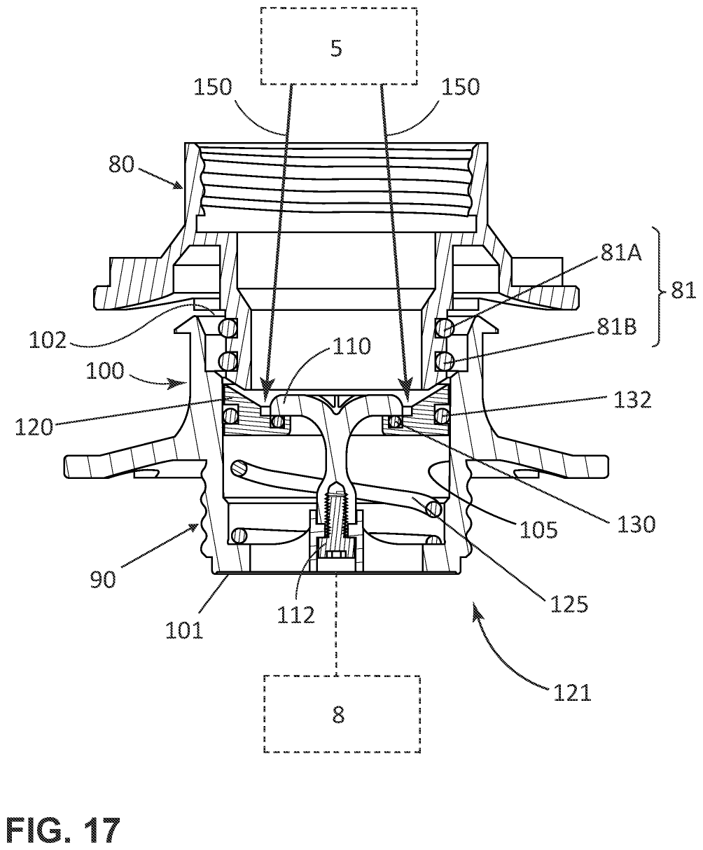

Referring now to FIG. 17, an improved valve 90 is illustrated that can be utilized in the system 1 (FIG. 1). The valve 90 can be in the form of a quick-disconnect self-sealing valve (QDSSV). The valve 90 can fluidly couple to a user's mask, such as the mask 8. An external component 80 can be configured to fluidly couple to an air supply, such as the source of breathable air 5. In this manner, the component 80 can fluidly couple the mask 8 and the valve 90 to the source of breathable air 5. In non-limiting examples the component 80 can include a filter, a filter adapter, a hose such as the breathing hose 70 (FIG. 16), a hose adapter, or the like. It will be understood that other external components or connectors not explicitly shown can nevertheless be coupled to the valve 90.

The valve 90 can include a housing 100 extending axially from a first end 101 to a second end 102. An air flow path 150 extends through the valve 90 between the first end 101 and the second end 102 . . . . The first end 101 can couple to the mask 8. In the example shown, the first end 101 can include a threaded connector for securing to the mask 8, such as a male Rd40-1/7 connector. The second end 102 can include a quick-disconnect connector for detachably securing to the component 80. In this manner, a user can mount the valve 90 onto the mask 8 and be able to quickly swap connected components or devices without risk of exposure to ambient contaminants.

The housing 100 further includes an interior surface 105. A central tee 110 can be positioned within the housing 100. The central tee 110 can be spaced from the interior surface 105. A fastener 112, such as a bolt, can also be provided for connecting the central tee 110 to the housing 100.

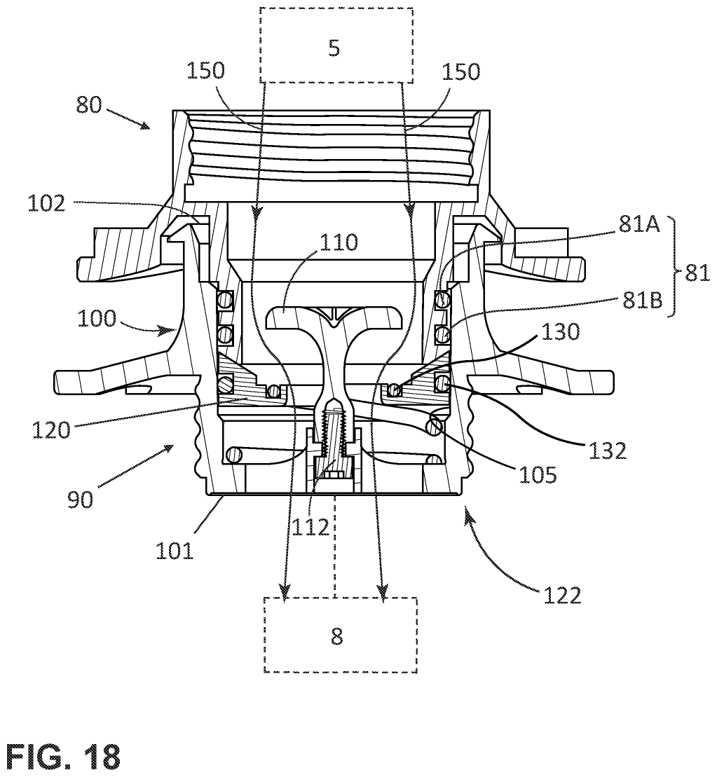

A shuttle 120 can also be provided within the housing 100. The shuttle 120 can be movable between a first position 121, as shown in FIG. 17, and a second position 122 as shown in FIG. 18. A spring 125 can also be provided within the housing 100 and coupled to the shuttle 120. The spring 125 can bias the shuttle 120 to the first position 121 as shown.

At least one seal can be provided in the breathing apparatus system 1 for selectively opening or blocking the air flow path 150. In the illustrated example, the component 80 can include a first seal 81. As shown, the first seal 81 includes an upper seal 81A and a lower seal 81B though any number of seals can be provided. The first seal 81 can include O-ring seals in a non-limiting example. The first seal 81 can engage the interior surface 105 of the housing 100 as shown.

The valve 90 can also include at least one seal. In the illustrated example, a second seal 130 is located within the housing and carried by the shuttle 120. A perimeter seal 132 can also be coupled to the shuttle 120 and engage the interior surface 105 of the housing 100. Any number of seals can be provided in the valve 90. The second seal 130 and the perimeter seal 132 can include O-ring seals in a non-limiting example. In an exemplary implementation, the second seal 130 and the perimeter seal 132 can be formed of an elastomeric material.

The shuttle 120 can be movable between a first position 121, as shown in FIG. 17, and a second position 122, as shown in FIG. 18. The spring 125 can bias the shuttle 120 such that the second seal 130 abuts the central tee 110 when in the first position 121.

In the first position 121 as shown, the component 80 is not yet engaged with the valve 90. In this configuration, the spring 125 can press the second seal 130 against an underside of the central tee 110, thereby forming a tight leak-proof seal by blocking the air flow path 150 as shown.

Axial insertion of the component 80 into the second end 102 can compress the spring 125 and move the shuttle 120 toward the first end 101. Turning now to FIG. 18, the valve 90 is illustrated wherein the component 80 engages the valve 90 by abutting and moving the shuttle 120 into the second position 122. The second seal 130 is spaced from the central tee 110, thereby opening the air flow path 150 through the valve 90.

When moving from the first position 121 of FIG. 17 toward the second position 122 of FIG. 18, the first seal 81 on the component 80 can seal to the interior surface 105, such as an inside wall of the bore of the housing 100, prior to breaking the leak-proof seal formed by the second seal 130 against the central tee 110. As the component 80 is inserted further into the valve 90, it can displace the shuttle 120 from the first position 121 to the second position 122 and open the air flow path 150 through the valve 90 to the component 80. It is also understood that removal of the component 80 can cause the spring-biased shuttle 120 to return to the first position 121, whereby the second seal 130 abuts the central tee 110 and closes the air flow path 150 prior to the first seal 81 of the component 80 releasing from the interior surface 105. In this manner, the second end 102 can be configured to fluidly couple with a source of breathable air. In addition, a sealed environment can be maintained within the valve 90 during both the connection and the removal of external components from the valve 90.

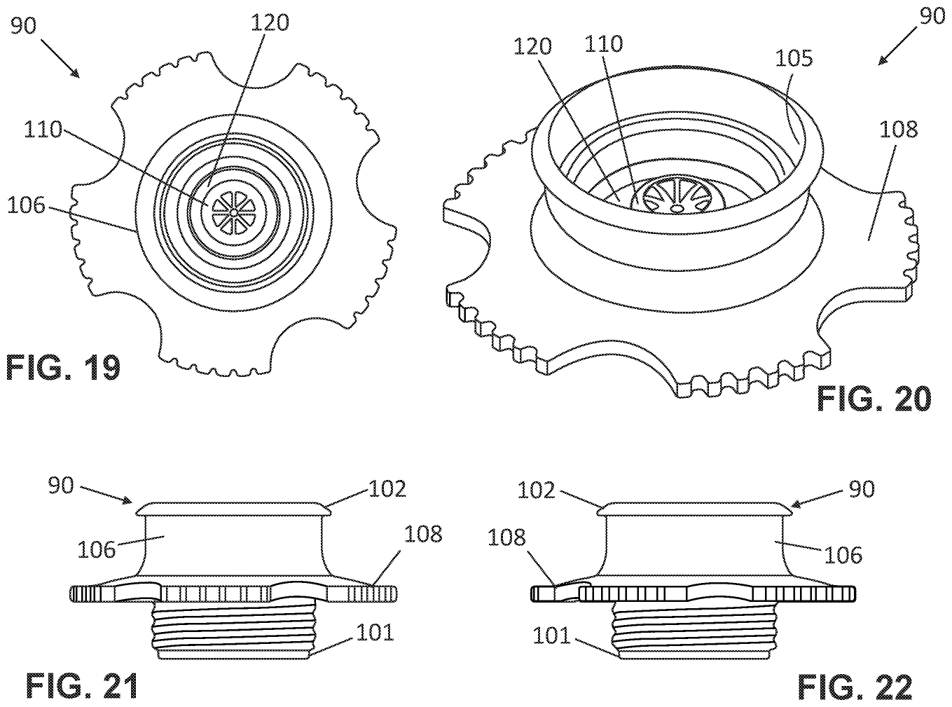

With general reference to FIGS. 19-22, the valve 90 is shown in isolation and with the shuttle 120 in the first position 121 as described in FIG. 17. The valve 90 can further include a central bore 106 having the interior surface 105 as shown. Insertion of an external component, such as the component 80 (FIG. 18), into the second end 102 can displace the shuttle 120 toward the first end 101 and away from the central tee 110. In addition, the housing 100 can further include a grip 108 projecting radially from the central bore 106. The grip 108 can provide increased surface area for improved accessibility when operating the valve 90. Such improved accessibility can include, for instance, when coupling or decoupling a component to the second end 102, or coupling or decoupling the valve 90 to the mask 8 (FIG. 18), or while wearing gloves or in a darkened environment, in non-limiting examples.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

Further aspects of the disclosure are provided by the following clauses:

A valve for a breathing apparatus system with a mask, the valve comprising: a housing extending axially from a first end to a second end, with the first end fluidly coupling to the mask and the second end configured to fluidly couple with a source of breathable air; an air flow path extending through the housing between the first end and the second end; a central tee located within the housing and at least partially defining the air flow path; a shuttle surrounding the central tee and movable between a first position and a second position; and a seal carried by the shuttle and surrounding the central tee.

The valve of any preceding clause, further comprising a spring within the housing and biasing the shuttle toward the first position.

The valve of any preceding clause, wherein the seal abuts the central tee and closes the air flow path when the shuttle is in the first position.

The valve of any preceding clause, wherein the seal is spaced from the central tee and opens the air flow path when the shuttle is in the second position.

The valve of any preceding clause, wherein the first end comprises a threaded connector.

The valve of any preceding clause, wherein the second end comprises a quick-disconnect connector.

The valve of any preceding clause, further comprising a perimeter seal coupled to the shuttle and engaging an interior surface of the housing between the first position and the second position.

A breathing apparatus system, comprising: a mask; a component fluidly coupled with the mask and having a first seal; and a valve receiving the component and comprising: a housing extending axially from a first end to a second end, with the mask coupled to the first end and the component coupled to the second end; an air flow path extending through the housing between the first end and the second end; a shuttle within the housing and movable between a first position and a second position; and a second seal carried by the shuttle and axially spaced from the first seal; wherein at least one of the first seal and the second seal block the air flow path as the shuttle is moved between the first position and the second position.

The breathing apparatus system of any preceding clause, further comprising a central tee located within the housing.

The breathing apparatus system of any preceding clause, further comprising a spring within the housing and biasing the shuttle toward the first position.

The breathing apparatus system of any preceding clause, wherein the component is axially insertable into the first end, thereby moving the shuttle from the first position toward the second position.

The breathing apparatus system of any preceding clause, wherein the second seal abuts the central tee and closes the air flow path when the shuttle is in the first position.

The breathing apparatus system of any preceding clause, wherein the first seal engages an interior surface of the housing when the shuttle is moved between the first position and the second position.

The breathing apparatus of any preceding clause, wherein, when the shuttle is moved from the first position to the second position, the first seal engages the interior surface and closes the air flow path prior to the second seal moving away from the central tee.

The breathing apparatus system of any preceding clause, wherein the second seal is spaced from the central tee and opens the air flow path when the shuttle is in the second position.

The breathing apparatus system of any preceding clause, wherein the first end comprises a threaded connector for securing to the mask.

The breathing apparatus system of any preceding clause, wherein the second end comprises a quick-disconnect connector for detachably securing to the component.

The breathing apparatus system of any preceding clause, wherein the component comprises one of a filter adapter or a hose.

The breathing apparatus system of any preceding clause, wherein each of the first seal and the second seal comprises an O-ring seal.

The breathing apparatus system of any preceding clause, further comprising a perimeter seal coupled to the shuttle and engaging an interior surface of the housing.

A valve system for a breathing apparatus system, comprising: a housing defining an interior and comprising an air inlet and an air outlet, the air inlet configured to fluidly couple to a source of breathable air; a proportional valve located within the interior and fluidly coupled to the air inlet; a pressure transducer electronically coupled to the micro proportional valve and configured to detect an air pressure and to transmit a signal indicative of the air pressure; and a controller in signal communication with the proportional valve and configured to operate the proportional valve based on the transmitted signal.

The valve system of any preceding clause, further comprising an electronic demand valve having the proportional valve.

The valve system of any preceding clause, wherein the proportional valve is a micro proportional valve.

The valve system of any preceding clause, wherein the detected air pressure is an internal mask air pressure.

The valve system of any preceding clause, wherein the proportional valve at least partially defines a first breath mechanism for the breathing apparatus system.

The valve system of any preceding clause, wherein the proportional valve at least partially defines a backup component providing breathable air based on a status of a second component in the breathing apparatus system.

A changeover system for a breathing apparatus system having multiple sources of breathable air, comprising: a switch operable between multiple discrete positions corresponding to the multiple sources of breathable air; a set of position sensors configured to detect a selected position of the switch and to provide a first signal indicative of the selected position, a set of environment sensors comprising at least one of a gas detection sensor, a pressure sensor, a temperature sensor, an acoustic sensor, or a voltage sensor, with the set of environment sensors configured to provide a signal indicative of a need to change the selected position of the switch.

The changeover system of any preceding clause, further comprising a sensor board having the switch, the set of position sensors, and the set of environment sensors.

The changeover system of any preceding clause, wherein the set of position sensors comprises Hall-effect sensors.

The changeover system of any preceding clause, wherein the set of position sensors comprises at least one of a rotary encoder or a potentiometer.

The changeover system of any preceding clause, further comprising a remote device in signal communication with the sensor board and transmitting a control signal for controllably operating the switch.

The changeover system of any preceding clause, further comprising a resistor array coupled to the set of position sensors.

The changeover system of any preceding clause, wherein the switch comprises one of a voice-activated switch or a manual switch.

The changeover system of any preceding clause, wherein the sensor board is in signal communication with the controller of the valve system.

1. A valve for a breathing apparatus system with a mask, the valve comprising:
a housing extending axially from a first end to a second end, with the first end fluidly coupling to the mask and the second end configured to fluidly couple with a source of breathable air;
an air flow path extending through the housing between the first end and the second end;
a central tee located within the housing and at least partially defining the air flow path;
a shuttle surrounding the central tee and movable between a first position and a second position; and
a seal carried by the shuttle and surrounding the central tee.

2. The valve of claim 1, further comprising a spring within the housing and biasing the shuttle toward the first position.

3. The valve of claim 2, wherein the seal abuts the central tee and closes the air flow path when the shuttle is in the first position.

4. The valve of claim 3, wherein the seal is spaced from the central tee and opens the air flow path when the shuttle is in the second position.

5. The valve of claim 2, wherein the first end comprises a threaded connector.

6. The valve of claim 5, wherein the second end comprises a quick-disconnect connector.

7. The valve of claim 2, further comprising a perimeter seal coupled to the shuttle and engaging an interior surface of the housing between the first position and the second position.

8. A breathing apparatus system, comprising:
a mask;
a component fluidly coupled with the mask and having a first seal; and
a valve receiving the component and comprising:
a housing extending axially from a first end to a second end, with the mask coupled to the first end and the component coupled to the second end;
an air flow path extending through the housing between the first end and the second end;
a shuttle within the housing and movable between a first position and a second position; and
a second seal carried by the shuttle and axially spaced from the first seal;
wherein at least one of the first seal and the second seal block the air flow path as the shuttle is moved between the first position and the second position.

9. The breathing apparatus system of claim 8, further comprising a central tee located within the housing.

10. The breathing apparatus system of claim 9, further comprising a spring within the housing and biasing the shuttle toward the first position.

11. The breathing apparatus system of claim 9, wherein the component is axially insertable into the first end, thereby moving the shuttle from the first position toward the second position.

12. The breathing apparatus system of claim 9, wherein the second seal abuts the central tee and closes the air flow path when the shuttle is in the first position.

13. The breathing apparatus system of claim 12, wherein the first seal engages an interior surface of the housing when the shuttle is moved between the first position and the second position.

14. The breathing apparatus system of claim 13, wherein, when the shuttle is moved from the first position to the second position, the first seal engages the interior surface and closes the air flow path prior to the second seal moving away from the central tee.

15. The breathing apparatus system of claim 13, wherein the second seal is spaced from the central tee and opens the air flow path when the shuttle is in the second position.

16. The breathing apparatus system of claim 8, wherein the first end comprises a threaded connector for securing to the mask.

17. The breathing apparatus system of claim 16, wherein the second end comprises a quick-disconnect connector for detachably securing to the component.

18. The breathing apparatus system of claim 17, wherein the component comprises one of a filter adapter or a hose.

19. The breathing apparatus system of claim 8, wherein each of the first seal and the second seal comprises an O-ring seal.

20. The breathing apparatus system of claim 8, further comprising a perimeter seal coupled to the shuttle and engaging an interior surface of the housing.
